(19) United States
(12) Patent Application Publication
(10) Pub. No.: US 2006/0075696 A1
(43) Pub. Date: Apr. 13, 2006

(54) Luminous door for display units, in particular for refrigerators and refrigerators fitted with the said door

(76) Inventor: Cremaschi Alessandro, Pavia (IT)

Correspondence Address: NOTARO AND MICHALOS, 100 DUTCH HILL ROAD, SUITE 110, ORANGEBURG, NY, 10962-2100, US

(21) Appl. No.: 11/231,145

(22) Filed: Sep. 20, 2005

(30) Foreign Application Priority Data
Oct. 8, 2004 (IT) MI2004A 001916

(51) Int. Cl. E06B 7/00

(52) U.S. Cl. 52/171.1

(57) ABSTRACT

The invention proposes a door of the kind composed of a double-glazing unit made of transparent material for display units or refrigerators, which is equipped with a panel made of transparent plastic material slotted into a double-glazing unit and which bears, on at least one side, a figure consisting of a plurality of slight superficial engravings, being the said panel lightened by a plurality of LEDs fitted just close one of its edges.

This invention proposes a door of the kind equipped with transparent door, consisting of a double-glazing unit, designed in particular for display units and/or refrigerators, wherein, inside the said double-glazing unit, a transparent panel is fitted, on the surface of which there appears a writing or a figure made by a plurality of slight superficial engravings and which is lightened by a series of LEDs placed on at least one inside edge of the perimetral gasket of the said double-glazing unit.

The light produced by the LEDs, while striking the said engravings, is diffused and creates an image which is visible in transparency.

As everybody knows, the food display units, and in particular the refrigerated display units, as the ones installed in bars, restaurants, supermarkets, etc. usually show on the top of the front side the brand name of manufacturer of the products displayed on sale, stuck by an adhesive film or other means on a back-lighted surface.

The said wording is therefore placed above the refrigerator door, which door is equipped with a transparent door made in such a way as to allow the user to see from the outside the products on sale.

Even though such visualisation system of the brand name on a back-lighted surface appears to be very popular in most of the refrigerators and display units of the prior art, it has some disadvantages:
anyone can easily remove the film bearing the supplier's brand name and replace it with another brand name, in order to display products of competitors, thus exploiting without any efforts or expenses and successfully a display unit of a firm already well-established in the relevant market segment;
the back-lighted part needs a lighting system with all the relevant disadvantages related to the presence of a line voltage electrical system, such as problems of insulation, protection, safety, compliance with the regulations and certification, as well as waste of the space required to lodge all the said components.

This invention falls into this sector, which invention aims at removing the above-mentioned disadvantages; by proposing the insertion of a Plexiglas panel or other transparent plastic material into the hollow space of the door double-glazing unit, being the said panel engraved with the supplier's brand name and the said engraving lighted by a plurality of LEDs fitted on at least one inside edge of the perimetral gasket of the double-glazing unit.

Further advantages and features will made clear by the following description and by the drawings annexed hereto, which are here provided by way of example but without any limitation thereto, in which:

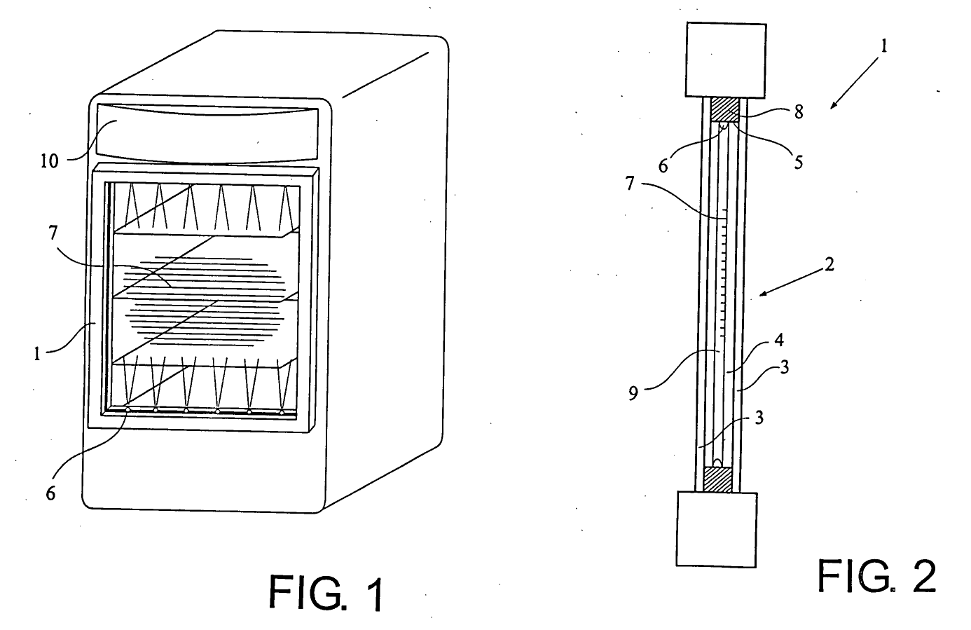

FIG. 1 is the view of a refrigerated display unit with a door according to this invention;

FIG. 2 is the sectional view of the door according to this invention.

With reference to the said figures, 1 shows, as a whole, a door the transparent part of which consists of a double-glazing unit 2, of the kind composed of two or more sheets of glass or other transparent material 3, with a perimetral insulating layer fitted thereinto, which borders, between the two sheets of glass, a double-glazing unit which can be kept vacuumised, or filled up with inert gas in order to improve the thermal insulation capacity.

On at least one inside edge 5 of the perimetral gasket 8 of the double-glazing unit 2, and therefore inside the glass as a whole, a plurality of LEDs 6 is fitted, made in such a way as to lighten a figure or a wording 7 composed of a series of slight superficial engravings made on a Plexiglas panel or other transparent material 9, also fitted inside the double-glazing unit, parallel to the two sheets of glass.

The LEDs 6 are fitted along at least one edge of the Plexiglas panel in such a way as to lead their luminous flux along the main plane of the panel 9.

The luminous rays, passing through the panel along its main axis, strike with light the engravings which are therefore lightened, diffusing part of the light, without interfering with the visibility through the panel.

The light diffused by the engraving reproduces the brand name outline which is thus visible also from afar, superimposed to the products contained in the refrigerator.

As a result of the foregoing, an overall attractive image of a luminous brand name is produced, visible on the door glass, with the products on sale displayed and well-lightened visible in transparency.

Among the different tested materials, Plexiglas is the one which gave the best results, as far as the visibility both of the brand name and the displayed product is concerned.

It is also possible to use other materials, such as glass or different types of transparent plastic for the same results, even though with less brilliant performances.

This solution makes the replacement of the brand name difficult by the user, since the change of the brand name would require the replacement of the double-glazing unit with another one having a panel engraved with a different logo, which operation would be possible only for the refrigerators' manufacturers, thus deterring any possible attempts of counterfeiting.

A further advantage deriving from the use of a door according to this invention is represented by the possibility to avoid the installation of lighting electric equipment of the front side of the device for the lighting of the brand name.

Since the LEDs are powered by current at lower voltage, generally ranging between 5 and 24 volts in direct current, the general safety of the refrigerator is improved and the risks of accidents due to malfunctions or failures or aging of the electric system are considerably reduced.

As a result of the foregoing, also the current consumptions for lighting will be reduced and the complex certifications which guarantee the compliance with strict safety regulations will not be necessary.

As it will be clear from the description above, a refrigerator equipped with doors with luminous and transparent panel and brand name according to this invention turns out to be safer, less expensive as regards the electricity consumption and will prevent the owner of the premises wherein the equipment is installed from replacing the brand name with another one.

A skilled in the art may make changes and different versions which must be all considered included within the competence of this invention as defined by the appended claims.

1. Transparent door for luminous displays in particular for refrigerators characterized in that it provides for a panel made of transparent material lightened by a side source of light fitted just close an edge of the said panel, and in which, on at least a surface of the said panel, there is a figure made by a series of small superficial engravings on one side of the said panel, in such a way that these engravings, stricken by the light coming from the panel edge, create a luminous image.

2. Transparent door of the kind equipped with double-glazing unit for luminous display units and refrigerators according to claim 1, characterized in that it provides for, in the hollow space of the said double-glazing unit, a panel made of transparent material lightened by a side source of light fitted just close an edge of the said panel, and in which, on at least a surface of the said panel there is a figure made by a series of small superficial engravings on one side of the said panel, in such a way that these engravings, stricken by the light coming from the panel edge, create a luminous image.

3. Transparent door for display units and refrigerators according to the claim 1, characterized in that the said source of light consists of LEDs.

4. Transparent door for display units and refrigerators according to the claim 3, characterized in that the said panel is made of plastic material.

5. Transparent door for display units and refrigerators according to the claim 4, characterized in that the said panel is made of Plexiglas.

6. Transparent door for display units and refrigerators according to the claim 3, characterized in that the said panel is made of glass.

7. (canceled)
